(19) United States
(12) Patent Application Publication
(10) Pub. No.: US 2011/0208420 A1
(43) Pub. Date: Aug. 25, 2011

(54) Navigation system provided by combination of global position system and global system for mobile communication

(76) Inventors: Cheng-Yuan Chang, Taoyuan County (TW); Yu-Feng Lin, Taoyuan County (TW); Tai-Yu Tsou, Taoyuan County (TW)

(21) Appl. No.: 12/978,398

(22) Filed: Dec. 23, 2010

(30) Foreign Application Priority Data
Feb. 24, 2010 (TW) 099105227

(51) Int. Cl. G01C 21/00

(52) U.S. Cl. 701/201

(57) ABSTRACT

The present invention is a combination of GPS (Global Position System) and GSM (Global System for Mobile Communication) navigation system. By using the data of GPS and SMS (Short Message Service), the present invention can display navigation directions and relative positions and send short message with positions. Therefore, a navigation system with active navigation guiding and help seeking is provided.

### BACKGROUND OF THE INVENTION

1. Field of the Invention

The invention relates to a navigation system and a navigating method, especially, a navigation system and a navigating method with active navigation guiding and help seeking

2. Description of the Prior Art

Currently on the market, the widely used mobile communication system is the global mobile communications (GSM), which has the high-quality voice phone and the function of sending a message service. In the GSM network, the message channel (control channel) is different from the channel used by general phone calls. In this way, even if the receiving terminal were in a call, it still could receive the message. If the other phone turned off or could not receive the message, the Short Message Service Center (SMSC) keeps the message for 24 hours. Then the message is automatically sent repeatedly at regular intervals, until the other handset receives the message so as to ensure the reliability of message transmission and reception. Besides, the sending time of message is short, and we can send a message to more than one receiver at the same time. Based on the above advantages, these message features should be made good use of to develop a variety of product applications.

Global satellite positioning system, researched and developed by the U.S. Department of Defense, is the satellite positioning system covering the whole world. Each satellite can launch the radio signals about coordinates and time. Wherever we are, at least four satellite signals can be received. The received signals could be the basis of positioning, navigation and measurement. For a long time, the global position system (GPS) is mainly for military purposes, but it has been gradually widely used in navigation, emergency rescue, construction, and other fields. As long as not shielded, the GPS positioning signals can be received by any person. It is believed that the free GPS could be helpful in life, industry and security.

In the past, a number of new inventions and applications combine GMS and GPS. For example, the U.S. Pat. No. 7,742,873 states a navigation guidance system which provides direction information from a remote server to a mobile user unit for guiding user to a desired destination; and the U.S. Pat. No. 7,746,271 states a method of increasing accuracy of a global position of a user receiver determined by a navigation system. Besides, Taiwan Pat. No. 1310081 “METHOD AND SYSTEM FOR SHARING NAVIGATION INFORMATION” disclosed a navigating method and system of information sharing. Its navigation information sent via SMS (short message service) to other people to help others find the right path to save the help seeking person, but the prior arts didn't navigate the help seeking person to the right place. Furthermore, Taiwan patent No. 1250772 “MOBILE PHONE WITH AUTOMATICALLY EMERGENT CALLING FUNCTION AND METHOD THEREOF” disclosed an invention using text messages to transmit current location information to others. As there is no active navigation function, what the emergency callers could do is just waiting for rescue.

Therefore, this invention combine SMS system and GPS system created an emergency system and a emergency method with active navigation system.

### SUMMARY OF THE INVENTION

The invention combines the characteristic of SMS with information of GPS to design an active help seeking system. The system can send the message of user's location, and indicate the direction and distance of default destination. Having the functions of active navigation and sending help seeking messages, the invention is better than the well-known passive help seeking system.

The present invention is related to a navigation system comprising: a destination setting module for setting the location of default destination, a GPS module for receiving coordinates data of global positioning satellite, a SMS module for sending text messages containing current location information obtained from said GPS module, and a destination guiding module for guiding users forward toward said default destination, which characterized in that the said destination guiding module can directly indicate the direction of said default destination and the distance between said default destination and current location.

The present invention is also related to a navigation system, further comprising an electronic compass module for calibrating the navigation system position. Besides, the invention discloses a navigation system, wherein the destination guiding module can indicate the direction and distance of said default destination without the need of electronic map, or wherein the SMS module can receive text messages from other phone to control the operation of the navigation system, or wherein the destination guiding module can use images or voice instructions indicating the direction and distance of said default destination.

Moreover, the present invention is related to a navigating method comprising: destination setting function for setting the location of default destination, GPS function for receiving coordinates data of global positioning satellite, SMS function for sending text messages containing current location information obtained from said GPS module, and destination guiding function for guiding users forward toward said default destination, which characterized in that the said destination guiding function can directly indicate the direction of said default destination and the distance between said default destination and current location.

The present invention is also related to a navigating method, further comprising an electronic compass function for calibrating the navigation system position. Besides, the invention discloses a navigating method, in which the destination guiding function can indicate the direction and distance of said default destination without the need of electronic map, or the SMS function can receive text messages from other phone to control the operation of the navigation system, or the destination guiding function can use images or voice instructions indicating the direction and distance of said default destination.

### BRIEF DESCRIPTION OF THE DRAWINGS

FIG. 1 is the flow chart of destination setting.

FIG. 2 is the flow chart of help seeking.

FIG. 3 is the flow chart of navigation.

FIG. 4 is the flow chart of search/tracking.

### DESCRIPTION OF THE PREFERRED EMBODIMENT

One embodiment of the navigation system of the present invention comprises a destination setting module, a GPS module, a SMS module, a destination guiding module, and an electronic compass, in which said destination setting module can set the location of default destination, said GPS module can receive coordinates data of global positioning satellite, said SMS module can send text messages containing current location information obtained from said GPS module or receive controlling messages from other user, said destination guiding module can guide users forward toward said default destination and directly indicate the direction of said default destination and the distance between said default destination and current location, and said electronic compass can adjust the direction of navigation system.

The navigation system of the invention has the following buttons to perform the corresponding functions:

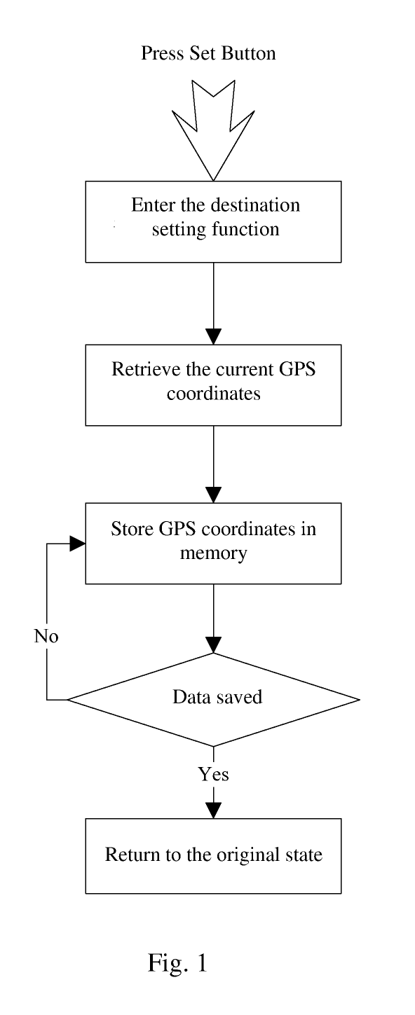

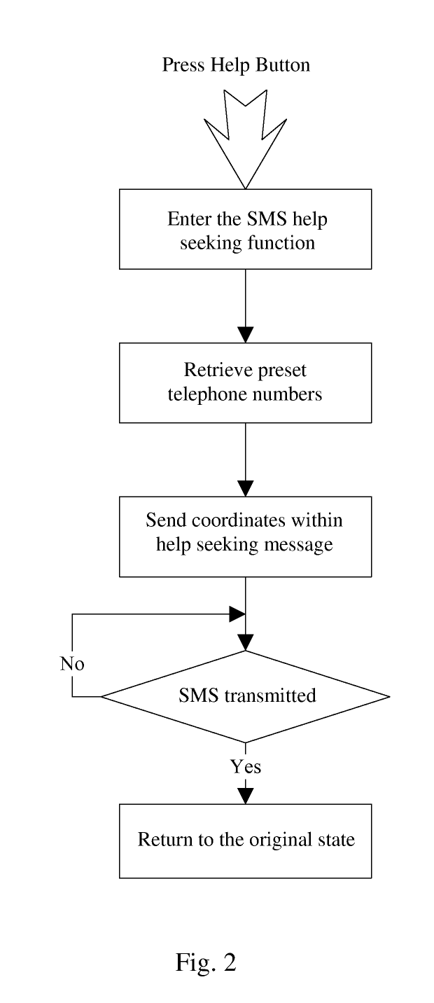

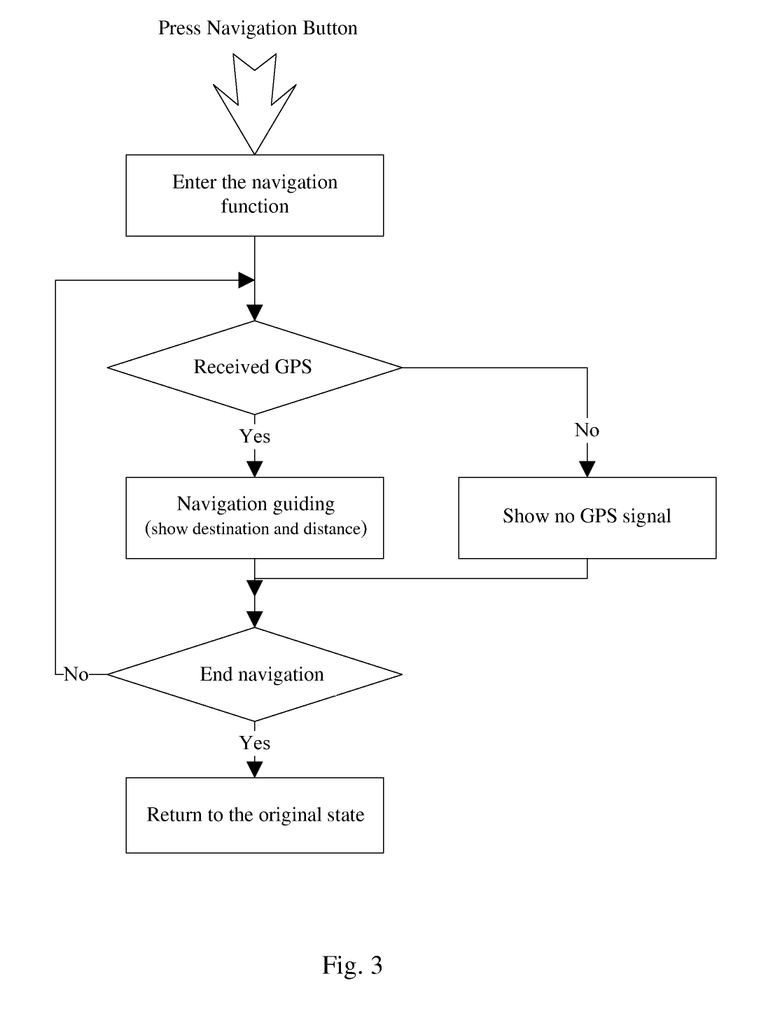

1. “Set Button”: Enter the destination setting function. By pressing this button, the system will immediately retrieve the current GPS coordinates of the location, which will be sent to the microcontroller as default navigation destination and stored in memory. When restarting, the system will get the destination coordinates and send it to the microcontroller. The process is shown in the flow chart as FIG. 1.
2. “Help Button”: Enter the SMS help seeking function. If this signal is triggered, the system will immediately retrieve the current GPS coordinates and send the coordinates within a help seeking message to one or multiple phones. When the user's family or friends or the rescue receive the help seeking messages, they can find the user asking for help. The process is shown in the flow chart as FIG. 2.
3. “Navigation Button”: Enter the navigation function. The design of the navigation direction may not only use arrow to indicate the direction indicators, but also display the distance between current location and destination. The process is shown in the flow chart as FIG. 3.

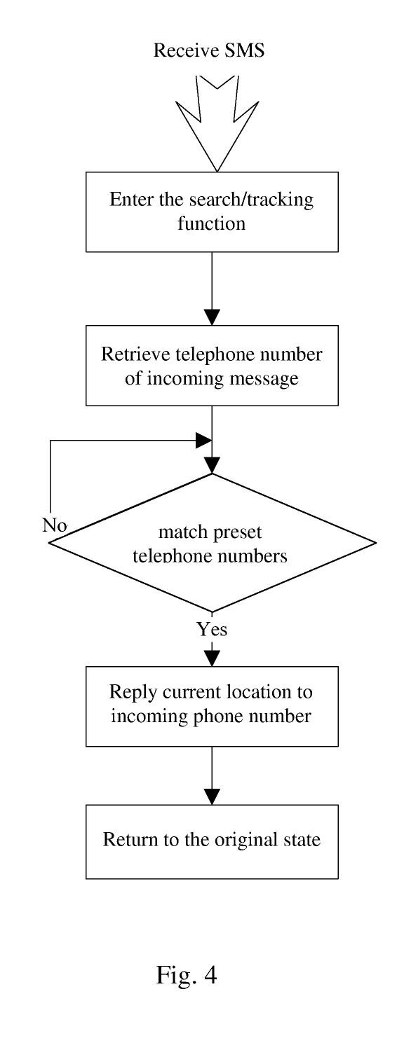

Besides, when someone else worries about the navigation system holder having an accident, he can enter the search/tracking function by way of SMS. When the system receives a message, the message will be immediately analyzed and incoming call number will be compared with one or more preset telephone numbers in the telephone directory. If the incoming call number matched the preset number, the navigation system will then immediately reply with current location coordinates received from GPS to the incoming phone number by SMS. If none of the preset number matched, the navigation system will return to the original state. The process is shown in the flow chart as FIG. 4.

The test results of one navigation system embodiment of the invention are shown in Table 1. When the distance between the current location and destination is 7598 meters, the calculated straight-line distance is 7650 meters. The navigation error is only 52 meters, less than 1%. Fortunately, as the user gets closer to the destination, the navigation error is smaller.

TABLE 1
The results of navigation system embodiment of the invention

| | |
|---|---|
| Destination | (24.8254, 121.0845) |
| (north latitude, east longitude) | |
| Test location | (24.8611, 121.0198) |
| (north latitude, east longitude) | |
| Calculated distance (m) | 7650.03 |
| Angle (degree) | 58.7 |
| Angle of electronic compass (degree) | 310 |
| Navigation direction | two o'clock |
| Real distance (m) | 7598 |
| Distance error (m) | 52 |

In the above embodiment, a number of processing units have been described. As those skilled in the art will appreciate, the above embodiment of the invention is not intended to limit the scope of the invention.

What is claimed is:

1. A navigation system comprising:
a destination setting module for setting the location of default destination;
a GPS module for receiving coordinates data of global positioning satellite;
a SMS module for sending text messages containing current location information obtained from said GPS module;
a destination guiding module for guiding users forward toward said default destination; and
an electronic compass module for calibrating the navigation system position;
characterized in that the said destination guiding module can directly indicate the direction of said default destination and the distance between said default destination and current location.

2. A navigation system according to claim 1, wherein said destination guiding module can indicate the direction and distance of said default destination without the need of electronic map.

3. A navigation system according to claim 1, wherein said SMS module can receive text messages from other phone to control the operation of the navigation system.

4. A navigation system according to claim 1, wherein said destination guiding module can use images or voice instructions indicating the direction and distance of said default destination.

5. A navigating method comprising:
destination setting function for setting the location of default destination;
GPS function for receiving coordinates data of global positioning satellite;
SMS function for sending text messages containing current location information obtained from said GPS module; and
destination guiding function for guiding users forward toward said default destination, characterized in that the said destination guiding function can directly indicate the direction of said default destination and the distance between said default destination and current location.

6. A navigating method according to claim 5, wherein said destination guiding function can indicate the direction and distance of said default destination without the need of electronic map.

7. A navigating method according to claim 5, further comprising: electronic compass function for calibrating the navigation system position.

8. A navigating method according to claim 5, wherein said SMS function can receive text messages from other phone to control the operation of the navigation system.

9. A navigating method according to claim 5, wherein said destination guiding function can use images or voice instructions indicating the direction and distance of said default destination.
